(19) United States
(12) Patent Application Publication
(10) Pub. No.: US 2018/0082413 A1
(43) Pub. Date: Mar. 22, 2018

(54) IMAGE SURVEILLANCE APPARATUS AND IMAGE SURVEILLANCE METHOD

(71) Applicant: NEC CORPORATION, Tokyo (JP)

(72) Inventors: Yasuji SAITO, Tokyo (JP); Junpei YAMASAKI, Tokyo (JP)

(73) Assignee: NEC CORPORATION, Tokyo (JP)

(21) Appl. No.: 15/558,599

(22) PCT Filed: Feb. 19, 2016
(86) PCT No.: PCT/JP2016/054816

§ 371 Date: Sep. 15, 2017

(30) Foreign Application Priority Data
Mar. 18, 2015 (JP) 2015-055242

(51) Int. Cl. G06T 7/00; H04N 7/18; G06F 3/14

(52) U.S. Cl. CPC G06T 7/001; H04N 7/181; G06T 2207/30184; G06T 2207/30232; G06F 3/14

(57) ABSTRACT

An image surveillance apparatus (100) includes an event acquisition unit (101) that acquires event information, a comparison unit (102) that compares images captured before and after a reference time corresponding to the acquired event information, among images captured by an imaging apparatus, and a display processing unit (103) that outputs a display corresponding to a result of the comparison to a display unit.

### TECHNICAL FIELD

The present invention relates to an image surveillance technique.

### BACKGROUND ART

Various methods of surveilling an image captured by a camera have been proposed. Patent Document 1 proposes a method of preventing erroneous failure detection in a mobile object on the basis of peripheral images and position information of the mobile object. In this method, the peripheral images of the mobile object are continuously acquired, and the position information of the mobile object is acquired in accordance with the acquisition of the peripheral images. In this method, failure is determined when, upon comparing peripheral images at different acquisition times, there is a change in position information at different acquisition times, and peripheral images at different acquisition times are the same as each other. In addition, Patent Document 2 proposes a method of calculating a point in time of appearance of an object to be watched in a plurality of temporally continuous images captured by an imaging apparatus. In this method, the object to be watched is detected from a first image at a first point in time, and the first image and each of one or more second images which are one or more images at a point in time before the first point in time are compared with each other, to calculate a point in time of appearance of the object to be watched.

### RELATED DOCUMENTS

### Patent Documents

[Patent Document 1] Japanese Patent Application Publication No. 2014-11476
[Patent Document 2] Japanese Patent Application Publication No. 2014-86797

### SUMMARY OF THE INVENTION

### Technical Problem

However, the above-described proposed method makes no comparison between images in consideration of an event that has occurred.

The present invention is contrived in view of such circumstances, and an object thereof is to provide an image surveillance technique capable of providing information indicating the influence of a certain event.

### Solution to Problem

In each aspect of the present invention, each of the following configurations is adopted in order to solve the above-mentioned problem.

A first aspect relates to an image surveillance apparatus. According to the first aspect, there is provided an image surveillance apparatus including: an event acquisition unit that acquires event information; a comparison unit that compares images captured before and after a reference time corresponding to the acquired event information, among images captured by an imaging apparatus; and a display processing unit that outputs a display corresponding to a result of the comparison to a display unit.

A second aspect relates to an image surveillance method which is executed by at least one computer. According to the second aspect, there is provided an image surveillance method including: acquiring event information; comparing images captured before and after a reference time corresponding to the acquired event information, among images captured by an imaging apparatus; and outputting a display corresponding to a result of the comparison to a display unit.

Note that another aspect of the present invention relates to a program causing at least one computer to execute the method according to the second aspect. In addition, another aspect relates to a computer readable storage medium having such a program stored thereon. This storage medium includes a non-transitory tangible medium.

### Advantageous Effects of Invention

According to each of the aspects, it is possible to provide information indicating the influence of a certain event.

### BRIEF DESCRIPTION OF THE DRAWINGS

The above and other objects, features, and advantages will be made clearer from certain preferred embodiments described below, and the following accompanying drawings.

FIG. 1 is a diagram conceptually illustrating a hardware configuration example of a surveillance system in a first example embodiment.

FIG. 2 is a diagram conceptually illustrating a process configuration example of an image server in the first example embodiment.

FIG. 3 is a diagram illustrating an example of images.

FIG. 4 is a diagram conceptually illustrating a relationship between the periodic transmission of image data and the storage of images.

FIG. 5 is a diagram conceptually illustrating a process configuration example of an image surveillance apparatus (surveillance apparatus) in the first example embodiment.

FIG. 6 is a diagram illustrating a specific example of a display output.

FIG. 7 is a flow diagram illustrating an operation example of the image surveillance apparatus (surveillance apparatus) in the first example embodiment.

FIG. 8 is a flow diagram illustrating a portion of an operation example (first method) of an image surveillance apparatus (surveillance apparatus) in a second example embodiment.

FIG. 9 is a flow diagram illustrating a portion of an operation example (second method) of the image surveillance apparatus (surveillance apparatus) in the second example embodiment.

FIG. 10 is a diagram illustrating an example of a table in which an event type and a predetermined time period are stored in association with each other.

FIG. 11 is a diagram conceptually illustrating a process configuration example of an image surveillance apparatus in a fourth example embodiment.

FIG. 12 is a flow diagram illustrating an operation example of the image surveillance apparatus in the fourth example embodiment.

### DESCRIPTION OF EMBODIMENTS

Hereinafter, embodiments of the present invention will be described. Note that the following respective example embodiments are illustrative, and that the present invention is not limited to the configurations of the following respective example embodiments.

### First Example Embodiment

[System Configuration]

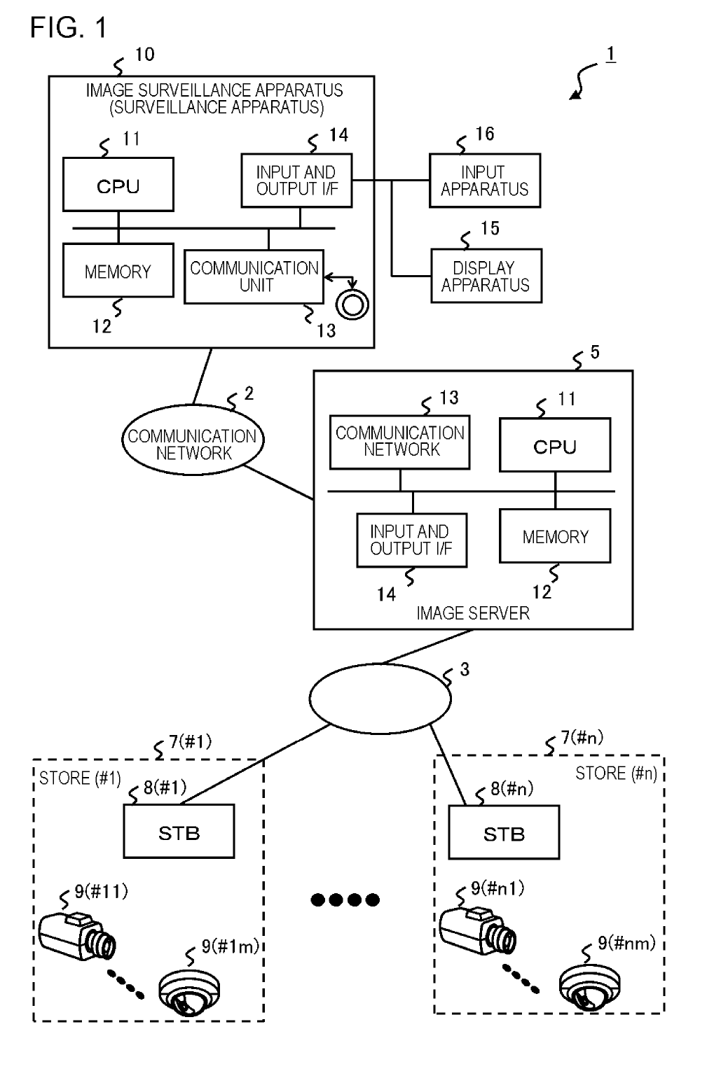

FIG. 1 is a diagram conceptually illustrating a hardware configuration example of a surveillance system 1 in a first example embodiment. The surveillance system 1 in the first example embodiment includes an image server 5, a plurality of in-store systems 7 disposed in a plurality of stores, an image surveillance apparatus (may be simply referred to as a surveillance apparatus hereinafter) 10, and the like. The surveillance system 1 surveils an image captured by each of the in-store systems 7. Since there is no limitation on the number of stores, the number of stores n is an integer equal to or greater than 1.

Each of the in-store systems 7 and the image server 5 are communicably connected to each other through a communication network 3, and the image server 5 and the surveillance apparatus 10 are communicably connected to each other through a communication network 2. The communication networks 2 and 3 are formed by one or more communication networks such as a cellular phone line network, a wireless fidelity (Wi-Fi) line network, an Internet communication network, a leased line network, a local area network (LAN), and a wide area network (WAN). In the present example embodiment, there is no limitation on specific communication configurations between the surveillance apparatus 10 and the image server 5 and between each of the in-store systems 7 and the image server 5.

The surveillance apparatus 10 is a so-called computer, and includes a central processing unit (CPU) 11, a memory 12, a communication unit 13, an input and output interface (I/F) 14, and the like, as shown in FIG. 1. These respective hardware elements are connected to each other through, for example, a bus or the like. The CPU 11 is equivalent to at least one of a general CPU, an application specific integrated circuit (ASIC), a digital signal processor (DSP), a graphics processing unit (GPU), and the like. The memory 12 is a random access memory (RAM), a read only memory (ROM), an auxiliary storage apparatus (such as a hard disk), or the like. The communication unit 13 communicates with another apparatus or another device in a wired or wireless manner. Specifically, the communication unit 13 is communicably connected to the communication network 2, and communicates with the image server 5 through the communication network 2. In addition, a portable storage medium or the like may also be connected to the communication unit 13.

A display apparatus 15, an input apparatus 16 or the like is connected to the input and output I/F 14. The display apparatus 15 is an apparatus, such as a liquid crystal display (LCD) or a cathode ray tube (CRT) display, which outputs display corresponding to drawing data processed by the CPU 11 or the like. The input apparatus 16 is an apparatus, such as a keyboard or a mouse, which receives an input by a user's operation. The display apparatus 15 and the input apparatus 16 may be formed integrally with each other, and be implemented as a touch panel. In a case where the surveillance apparatus 10 operates as a WEB server, the surveillance apparatus 10 may not include the display apparatus 15, and can also output display on a portable terminal (not shown) that has access to the surveillance apparatus 10.

The image server 5 is also a so-called computer, and includes a CPU 11, a memory 12, a communication unit 13, an input and output interface (I/F) 14, and the like. These respective hardware elements are as mentioned above.

Each of the in-store systems 7 includes a set-top box (STB) 8 and one or more surveillance cameras 9. Here, “m” indicating the number of surveillance cameras 9 is an integer equal to or greater than 1. However, the respective number of STBs 8 and surveillance cameras 9 included in the respective in-store systems 7 may be the same as or different from each other. In addition, an in-store system 7 that does not include the STB 8 may be present. In this case, each of the surveillance cameras 9 included in the in-store system 7 that does not include the STB 8 is communicably connected to the STB 8 of another store. In addition, each of the in-store systems 7, each of the STBs 8, and each of the surveillance cameras 9 are collectively termed reference numerals 7, 8 and 9, except for a case where these components are required to be particularly distinguished from each other.

The surveillance camera 9 is installed at a position and in a direction allowing to capture an image of an optional place to be surveilled, and sends a captured video signal to the STB 8. The surveillance camera 9 is communicably connected to the STB 8 in a wired or wireless manner. There is no limitation on a communication configuration and a connection configuration between the surveillance camera 9 and the STB 8.

The STB 8 is communicably connected to one or more surveillance cameras 9. The STB 8 receives a video signal from each of the surveillance cameras 9, and records the received video signal. That is, the STB stores recorded data for each of the surveillance cameras 9. On the other hand, the STB 8 sequentially acquires image (still image) data by capturing the received video signal at a predetermined cycle (for example, a one-minute cycle). Thereby, a plurality of pieces of images data acquired for each of the surveillance cameras 9 indicate images captured by the surveillance camera 9 at intervals of a predetermined cycle, that is, images at a plurality of predetermined imaging times. The STB 8 may extract the image data from the recorded data.

The STB 8 sequentially transmits the acquired image data, together with identification information of the surveillance camera 9 having captured the image, to the image server 5. In addition, the STB 8 can also transmit imaging time information of the image of the image data, together with the image data and the identification information of the surveillance camera 9. The imaging time information can be acquired when the image data is extracted from the video signal or the recorded data. In addition, the STB 8 can also extract image data at a predetermined cycle (for example, one second) shorter than the aforementioned predetermined cycle according to an instruction from another apparatus to sequentially transmit the image data to the another apparatus.

The hardware configuration shown in FIG. 1 has been described for exemplary purposes only, and the hardware configurations of the surveillance apparatus 10 and the image server 5 are not limited to the example shown in FIG. 1. The surveillance apparatus 10 and the image server 5 may include another hardware element which is not shown in the drawing. In addition, the number of apparatuses and the number of hardware elements of each apparatus are also not limited to the example of FIG. 1. For example, the surveillance system 1 may include a plurality of image servers 5, and the surveillance apparatus 10 and the image server 5 may include a plurality of CPUs 11.

[Process Configuration]

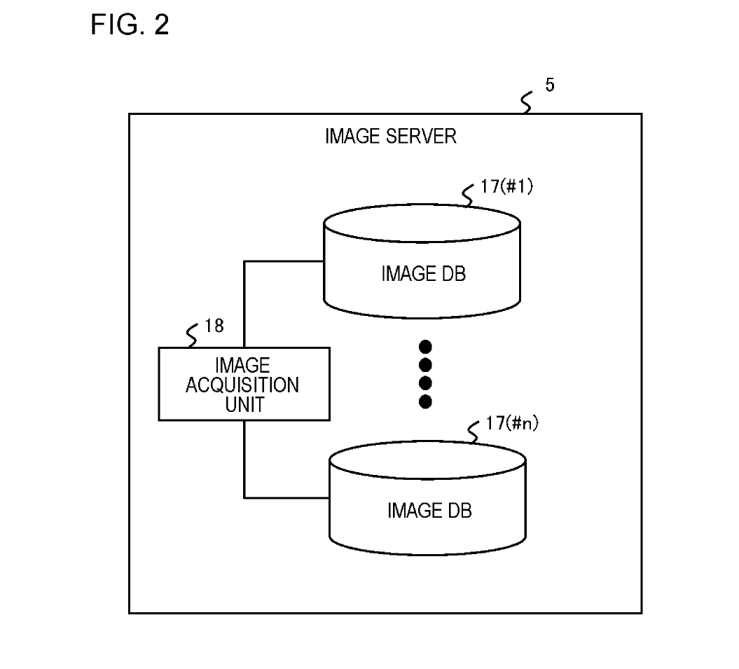

FIG. 2 is a diagram conceptually illustrating a process configuration example of the image server 5 in the first example embodiment. The image server 5 includes an image database (DB) 17, and image acquisition unit 18 and the like for each store. The image DB 17 and the image acquisition unit 18 are implemented by executing, for example, a program stored in the memory 12 by the CPU 11. In addition, the program may be installed through the communication unit 13 from a portable storage medium such as, for example, a compact disc (CD) or a memory card, or another computer on a network, and be stored in the memory 12.

The image DB 17 for each store stores image data periodically transmitted from the in-store system 7, for each of the surveillance cameras 9 having captured the image and in a time-series manner.

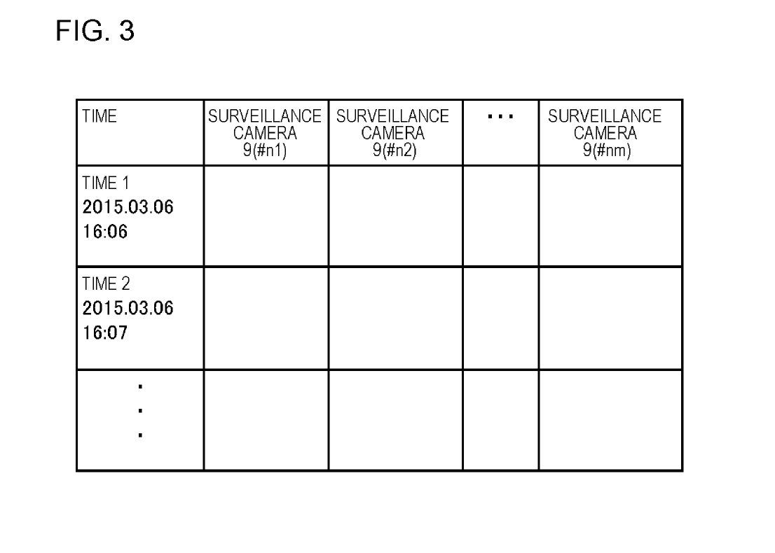

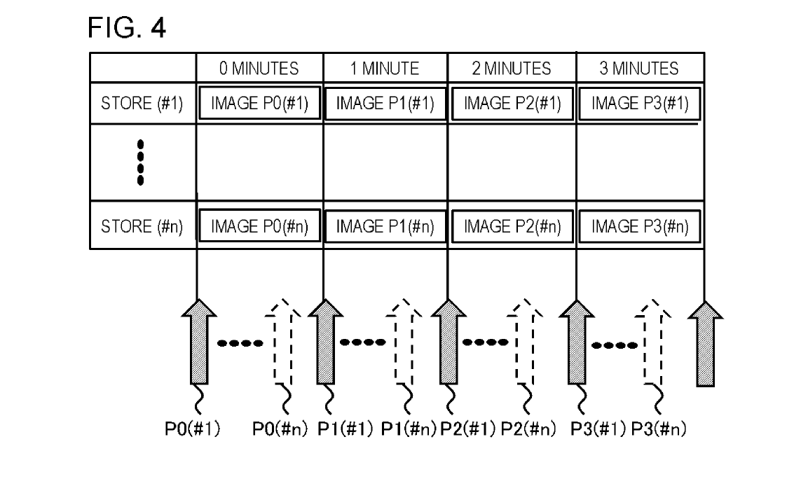

FIG. 3 is a diagram illustrating an example of the image DB 17. In the example of FIG. 3, the image DB stores image data for each of the surveillance cameras 9 together with each piece of time information. The time information stored together with image data indicates an imaging time of the image of the image data. In addition, the time information may indicate a cycle time of image data transmitted from the in-store system 7 and periodically received in the image server 5, the cycle time allowing to determine a cycle to which a time received in the image server 5 belongs. This cycle time will be described later with reference to FIG. 4. The image DB 17 is not limited to the example of FIG. 3. For example, the image DB 17 may not have the time information (such as 16:06, Mar. 6, 2015) itself stored therein. In this case, information indicating a cycle number allowing to determine a cycle to which a time at which image data is received in the image server 5 belongs may be stored instead of the time information. The time indicated by the time information, the cycle number or the like illustrated in FIG. 3 is set to a time of each piece of image data stored in the image DB 17.

The image acquisition unit 18 receives the image data periodically transmitted from each of the in-store systems 7 and the identification information of the surveillance camera 9, and sequentially stores the received image data in the image DB 17 for each of the surveillance cameras 9. The image acquisition unit 18 can determine in which store's image DB 17 the image data should be stored, using information of a transmission source of the image data. In addition, in a case where the image data is received together with the identification information of the surveillance camera 9 and imaging time information, the image acquisition unit 18 stores the image data for each of the surveillance cameras 9, together with the imaging time information, in the image DB 17.

FIG. 4 is a diagram conceptually illustrating a relationship between the periodic transmission of image data and the storage of the image DB 17. In the example of FIG. 4, periodic transmission timings of image data are shifted for each of the in-store systems 7, in order to avoid the congestion of communication. The solid arrows indicate transmission timings of the in-store system 7(#1), and transmission timings are allocated in order from the in-store system 7(#1) to the in-store system 7(#n). In a case where a certain transmission timing arrives, the image acquisition unit 18 sequentially acquires image data of the in-store system 7(#1) to image data of the in-store system 7(#n). The image acquisition unit 18 may determine a cycle time of each piece of received image data which indicates a cycle to which a time received in the image server 5 belongs, and store each piece of data of images captured by a plurality of surveillance cameras 9 in the image DB 17 of each store, in association with the cycle time. In the example of FIG. 4, image data is transmitted at a one-minute cycle from the in-store system 7, and the cycle times determined by the image acquisition unit 18 are “0 minutes”, “1 minute”, “2 minutes”, and “3 minutes”. For example, image data received from 10:00 to 10:01 is associated with a cycle time of “0 minutes”, and image data received from 10:01 to 10:02 is associated with a cycle time of “1 minute”.

Incidentally, there may be a case in which image data to be periodically transmitted from the in-store system 7 is not received by the image acquisition unit 18 of the image server 5, due to some kind of trouble. In such a case, only time information corresponding to the cycle is stored in the image DB 17, and image data associated with the time information is not stored therein. Hereinafter, the “image data” stored in the image DB 17 may be simply denoted as an “image”.

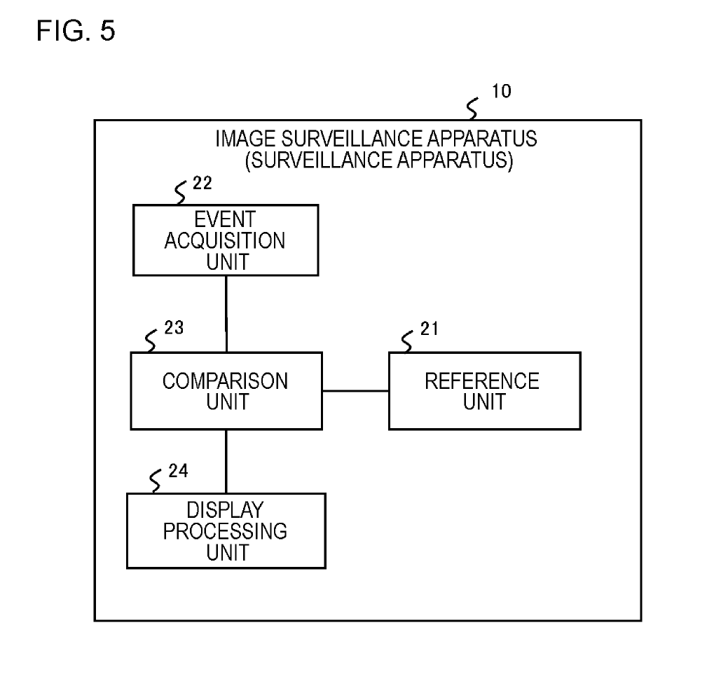

FIG. 5 is a diagram conceptually illustrating a process configuration example of the surveillance apparatus 10 in the first example embodiment. The surveillance apparatus 10 includes a reference unit 21, an event acquisition unit 22, a comparison unit 23, a display processing unit 24, and the like. The reference unit 21, the event acquisition unit 22, the comparison unit 23 and the display processing unit 24 are implemented by executing, for example, a program stored in the memory 12 by the CPU 11. The program is as described above.

The reference unit 21 has access to the image server 5 and refers to the image DB 17 for each store.

The event acquisition unit 22 acquires event information. The acquired event information is information, indicating a predetermined event, which is generated with the occurrence of the event. The predetermined event is selected from, for example, natural disasters such as earthquakes, landslides, mudflows, lightning strikes, tornados, typhoons, or volcanic eruptions, man-made disasters such as terrorisms, disputes, riots, automobile accidents, and the like. As long as the predetermined event is an event having the possibility of damaging a store, its contents are not limited. In the following description, an earthquake is exemplified as the predetermined event for ease of understanding. For example, the event acquisition unit 22 acquires an Earthquake Early Warning indicating the occurrence of an earthquake as the event information.

The event information may be information input by a user operating the input apparatus 16 or the input operation unit (not shown) of a portable apparatus (not shown) on the basis of an input screen or the like displayed on the display apparatus 15 or the display unit (not shown) of the portable apparatus, or may be information acquired through the communication unit 13 from a portable storage medium, another computer, or the like. For example, the event acquisition unit 22 may acquire the Earthquake Early Warning from the server of the Japan Meteorological Agency, or may acquire the Earthquake Early Warning through a user's input.

The comparison unit 23 compares images captured before and after a reference time corresponding to the event information acquired by the event acquisition unit 22, among images stored in the image DB 17 for each store which is referred to by the reference unit 21. The “reference time corresponding to the event information” may be a time of occurrence of an event indicated by the event information, or may be a time at which the event information is acquired by the event acquisition unit 22. For example, the comparison unit sets the time of occurrence of an earthquake, indicated by an Earthquake Early Warning acquired as the event information, as the reference time.

The comparison unit 23 compares an image captured before the reference time with an image captured after the reference time, for each of the surveillance cameras 9. Hereinafter, the image captured before the reference time may be denoted as a reference image. For example, the comparison unit 23 sets an image, associated with time information indicating a time before an event occurrence time (reference time or earthquake occurrence time) indicated by the acquired event information, as the reference image. In addition, the comparison unit 23 may set an image, which is associated with time information of a time before and closest to a point in time (reference time) at which the event information is acquired and stored in the image DB 17, as the reference image.

The comparison unit 23 determines the situation of damage on the basis of a result of comparison of an image before the reference time (reference image) with an image captured after the reference time. For example, the comparison unit 23 calculates a differential amount between the images. The comparison unit can determine damage to be present in a case where the differential amount is larger than a threshold, and determine damage not to be present in a case where the differential amount is smaller than the threshold. In addition, the comparison unit 23 can also determine the degree of damage in proportion to the differential amount. In addition, the comparison unit 23 can also calculate a difference between pixel values for each pixel, determine the presence or absence of a change for each pixel by binarizing the difference, and determine the situation of damage on the basis of the percentage of the number of changed pixels to the whole number of pixels. In this case, the comparison unit 23 can determine damage not to be present in a case where the percentage of the changed pixels is lower than a threshold, and determine damage to be present in a case where the percentage of the changed pixels is larger than the threshold. In addition, by using a plurality of thresholds, the comparison unit 23 can also determine the damage as any one of extensive damage, moderate damage, and slight damage.

Further, the comparison unit 23 may hold a background model included in a captured image for each of the surveillance cameras 9 through learning using an image group captured before the reference image. The background model is image information indicating a stationary body (such as a display shelf, a wall, a floor, or a door within a store) which is fixed and immobile. In addition, the comparison unit 23 may hold a representative feature value of a human image. The comparison unit 23 can also exclude an image region indicating a person (moving object) included in the reference image from a comparison target, using the background model or the representative feature value of the human image. In addition, the comparison unit 23 can also set only an image region corresponding to the background model as a comparison target to determine the situation of damage on the basis of a differential amount in comparison to the background model.

The comparison unit 23 determines the situation of damage of an imaging area of each of the surveillance cameras 9, on the basis of a result of comparison between images for each of the surveillance cameras 9 stored in the image DB 17 for each store. The comparison unit 23 collects the situation of damage of the imaging area of each of the surveillance cameras 9 for each store to thereby determine the situation of damage in each store.

The situation of damage determined by the comparison unit 23 may be the presence or absence of damage, or may be the degree of damage. For example, in a case where the number of surveillance cameras 9 within the same store, by which damage is determined to be present, is one or more or exceeds a predetermined number, the comparison unit 23 determines damage to be present with respect to the store. Otherwise, the comparison unit determines damage not to be present with respect to the store. In addition, the comparison unit 23 calculates damage points proportional to the differential amount between images for each of the surveillance cameras 9, and calculates damage points for each store by tallying up the damage points for each store. The comparison unit 23 can also determine damage to be present with respect to the store in a case where the damage points are larger than a predetermined value, and otherwise determine damage not to be present with respect to the store. The damage points for each store may be used, as it is, as the situation of damage for each store.

Incidentally, a power failure or the congestion of communication may be caused due to the occurrence of an event indicated by the acquired event information. In such a case, the periodic transmission of images from the in-store system 7 to the image server 5 is stopped, and thus there is the possibility of images not being stored in the image DB 17. Consequently, in a case where an image captured after the reference time by the surveillance camera 9 is not acquired, the comparison unit 23 may determine the situation of damage as unknown. In a case where the situation of damage is determined as unknown and thereafter a new image is acquired, the comparison unit 23 compares an image captured before the reference time with the new image, to thereby update the situation of damage determined as unknown to the situation of damage corresponding to a new result of comparison.

That is, the comparison unit 23 may determine any one of damage, no damage, and unknown as the situation of damage, with respect to each of the surveillance cameras 9. The comparison unit 23 may collect this determination result for each store, and thus determine any one of damage, no damage, and unknown as the situation of damage, with respect to each store. However, in a case where the situation of damage is determined as unknown, damage may or may not have actually occurred in the stores. Thus, in a case where there are no surveillance cameras 9 by which damage is determined to be present, and the number of surveillance cameras 9 by which damage is determined as unknown damage is one or more, for example, with respect to the same store, the comparison unit 23 determines the damage of the store to be unknown. On the other hand, in a case where the number of surveillance cameras 9 by which damage is determined to be present is a predetermined number or greater with respect to the same store, the comparison unit 23 determines damage to be present with respect to the store, even when a surveillance camera 9 is present by which it is determined damage is unknown.

Even in the method of determining the situation of damage as described above, there is the possibility of an occurrence of erroneous determination. In order to prevent erroneous determinations from occurring, it is preferable to determine the situation of damage of a store, as described above, by collecting the situation of damage determined with respect to a plurality of surveillance cameras 9 in one store. As the number of surveillance cameras 9 within a store becomes larger, it is possible to further decrease the possibility of an erroneous determination from occurring. In a case where a target event may inflict damage on a wide range of stores, it is possible to further decrease the possibility of an erroneous determination from being caused by further adding the situation of damage determined with respect to another store. That is, the comparison unit 23 determines the situation of damage to a store on the basis of the situation of damage determined with respect to the surveillance camera 9 installed in the store and the situation of damage determined with respect to another store. For example, in a case where another store determined to be damaged is present, the comparison unit 23 may also determine the store to be damaged.

A method of comparison between images and a method of determining the situation of damage based on the comparison result are not limited to the above-described example.

The display processing unit 24 outputs a display, in which information indicating the situation of damage determined by the comparison unit 23 is associated with images stored in the image DB 17, to the display apparatus 15. The display processing unit 24 may also set the output destination of the display to the display unit of another apparatus such as a portable terminal. Insofar as the damage situation information is displayed so that the damage situations are distinguishable from each other, there is no limitation to its specific display form. For example, colored frames indicating blue for no damage, red for damage, and yellow for unknown are displayed in a state of being attached to an image for each of the surveillance cameras 9. In addition, a character string or a drawing pattern indicating the situation of damage may be attached to the image for each of the surveillance cameras 9. Further, the image for each of the surveillance cameras 9 may be collectively displayed for each situation of damage.

The display processing unit 24 can output a display in which each piece of damage situation information is associated with each image, the image associated with the time information of a time closest to the reference time stored in the image DB 17. However, as described above, the image captured by the surveillance camera 9 may not be stored in the image DB 17 due to the occurrence of an event. In such a case, the image associated with the time information of a time closest to the reference time is not stored in the image DB 17, and the comparison unit 23 determines the situation of damage as unknown. In this case, the display processing unit 24 outputs a display associating information indicating non-acquisition of the image captured by the surveillance camera 9 with information indicating that the situation of damage is unknown. The information indicating non-acquisition of the image may be simply a black image or a white image, or may be a character string or a drawing pattern indicating to that effect. In addition, the information indicating that the situation of damage is unknown is included in the aforementioned damage situation information.

For example, the display processing unit 24 outputs a display associating, for each store, information indicating non-acquisition of a representative image or an image of a store stored in the image DB 17 for each store with information indicating the situation of damage determined with respect to the store. The representative image of each store is one image selected from a plurality of images which are captured by a plurality of surveillance cameras 9 included in each of the in-store systems 7, and are stored in the image DB 17 in association with the time information of a time closest to the reference time. The image associated with the time information of the time closest to the reference time is also denoted as a latest image.

The display processing unit 24 may select an image indicating the situation of damage determined by the comparison unit 23, as the representative image of each store, from a plurality of latest images for each store which are stored in the image DB 17 for each store. For example, in a case where the surveillance camera 9 by which damage is determined to be present and the surveillance camera 9 by which damage is determined not to be present are included in the in-store system 7 of a store determined to be damaged, the display processing unit 24 selects a latest image captured by the surveillance camera 9 by which damage is determined to be present, as the representative image of the store. Thereby, since the determined situation of damage and a status appearing on the image are coincident with each other, the display is easy to see.

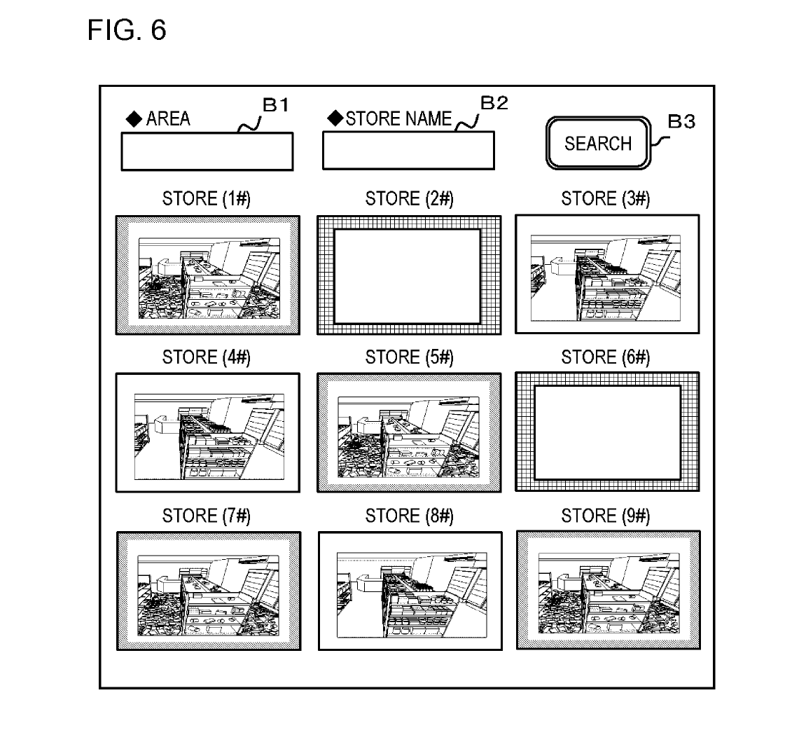

FIG. 6 is a diagram illustrating a specific example of a display output. In the example of FIG. 6, stores (#1), (#5), (#7) and (#9) are stores determined to be damaged, and the representative image of each store is displayed in a state of being surrounded by a finely hatched frame. In addition, stores (#3), (#4) and (#8) are stores determined to be undamaged, and the representative image of each store is displayed in a state of being surrounded by a white frame. Stores (#2) and (#6) are stores determined as unknown in damage. A white image is displayed as information indicating non-acquisition of the image, and the white image is displayed in a state of being surrounded by a checkered frame indicating unknown damage. The display form of information indicating non-acquisition of the damage situation information and the image is not limited to the example of FIG. 6. In addition, in the example of FIG. 6, in a case where data is input into an entry field B1 and a search button B3 is operated, a list of stores belonging to an area corresponding to the input data is displayed. In addition, in a case where data is input into an entry field B2 and the operation button B3 is operated, a list of stores having a store name corresponding to the input data is displayed.

The display processing unit 24 can also output a map display in which a display element is disposed at a position of each store, the display element associating the information indicating non-acquisition of the representative image or an image of a store with the information indicating the situation of damage of the store. According to this output, it is possible to check the situation of damage of each store at a glance on a map, useful for plan-making or the like to recover from the damage.

A power failure or a failed communication network is restored from a state where the storage of an image in the image DB 17 is delayed due to the occurrence of an event, and thus the storage of an image is resumed. By the resumption, the comparison unit 23 updates the situation as “unknown” to the situation of newly determined damage. In this case, the display processing unit 24 replaces the information indicating non-acquisition of the image with the new image, and changes the information indicating that the situation of damage is unknown to information indicating the updated situation of damage.

In addition, the display processing unit 24 can also output a display in which the damage situation information is associated with a latest image stored in the image DB 17, for each of the surveillance cameras 9, instead of a display for each store or together with display for each store. There is no limitation on a specific form of display, processed by the display processing unit 24, in which the image and the damage situation information are associated with each other.

[Operation Example/Image Surveillance Method]

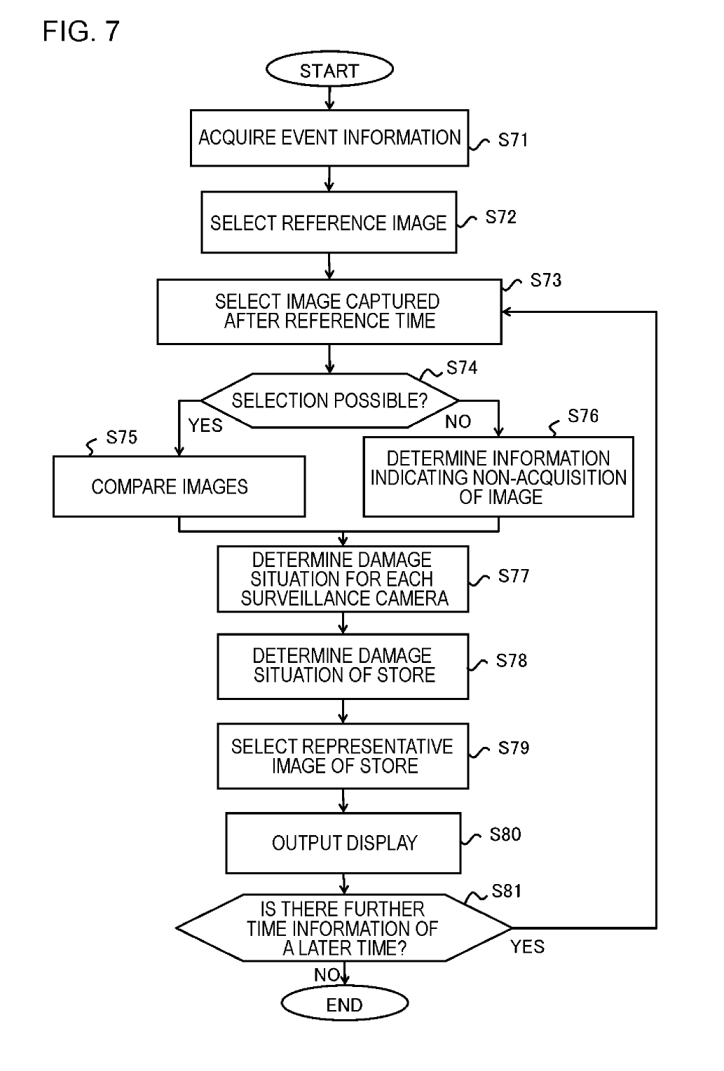

Hereinafter, an image surveillance method in the first example embodiment will be described with reference to FIG. 7. FIG. 7 is a flow diagram illustrating an operation example of the surveillance apparatus 10 in the first example embodiment. As shown in FIG. 7, the image surveillance method is executed by at least one computer such as the surveillance apparatus 10. Each of steps shown is executed by, for example, each processing module of the surveillance apparatus 10. Each step is the same as the aforementioned processing details of each processing module of the surveillance apparatus 10, and thus the details of each step will not be repeated.

The image server 5 sequentially acquires images periodically from a plurality of in-store systems 7 together with the operation of the surveillance apparatus 10 illustrated in FIG. 7, and stores the acquired images in the image DB 17 for each store, for each of the surveillance cameras 9. In this case, each image is stored in association with time information.

The surveillance apparatus 10 acquires event information (S71). The event information may be acquired by a user's input operation, and may be acquired from a portable storage medium, another computer or the like through the communication unit 13. For example, the surveillance apparatus 10 acquires an Earthquake Early Warning from the server of the Japan Meteorological Agency.

Step (S72) and subsequent steps are executed with respect to each of the in-store systems 7. Thus, the description of step (S72) and subsequent steps targets the in-store system 7 of any one store. In addition, the steps of (S72) to (S77) are executed with respect to each of the surveillance cameras 9 included in the in-store system 7 of the one store. Thus, the description of each step of (S72) to (S77) targets any one surveillance camera 9 included in the in-store system 7 of any one store.

The surveillance apparatus 10 selects an image captured before the reference time corresponding to the event information acquired in step (S71), among images captured by the surveillance camera 9 and stored in the image DB 17, as the reference image (S72). For example, the surveillance apparatus 10 selects an image, associated with time information indicating a time before the event occurrence time (reference time) indicated by the event information, as the reference image. In addition, the surveillance apparatus 10 may select an image, stored in the image DB 17 in association with time information of a time closest to the reference time before a point in time (reference time) at which the event information is acquired, as the reference image. For example, the surveillance apparatus 10 selects an image, associated with time information indicating a time before an earthquake occurrence time indicated by an Earthquake Early Warning, as the reference image. In this manner, the selected reference image is an image captured before the occurrence of an event, and thus indicates a status within a store during the normal time.

The surveillance apparatus 10 selects an image captured after the reference time among the images captured by the surveillance camera 9 and stored in the image DB 17, as a comparison target (S73). In a case where the image can be selected in step(S73), the surveillance apparatus 10 compares the reference image selected in step (S72) with the image selected in step (S73) (S75). A method of comparison between images is as described above. On the other hand, since the selection in step (S73) cannot be performed in a case where the image captured after the reference time is not stored in the image DB 17 (S74; NO), the surveillance apparatus 10 determines information indicating non-acquisition of an image (S76).

The surveillance apparatus 10 determines the situation of damage of the surveillance camera 9 on the basis of the result of the comparison between images in step (S75) (S77). Since the comparison between images has successfully been made, the surveillance apparatus 10 determines damage to be present or damage not to be present with respect to the surveillance camera 9. The surveillance apparatus 10 can also calculate the degree of damage with respect to the surveillance camera 9. A method of determining the situation of damage is as described above. For example, the surveillance apparatus 10 compares the reference image indicating a status within a store during the normal time with an image indicating a status within the store having suffered damage, and thus can determine damage to be present with respect to the surveillance cameras 9 having captured both the images. On the other hand, in a case where the information indicating non-acquisition of an image is determined (S76), the surveillance apparatus 10 determines the situation of damage to be unknown (S77).

The surveillance apparatus 10 executes steps (S72) to (S77) with respect to each of the surveillance cameras 9 included in the in-store system 7, and thus determines the situation of damage with respect to each of the surveillance cameras 9. The surveillance apparatus 10 determines the situation of damage of the store on the basis of the situation of damage determined with respect to each of the surveillance cameras 9 (S78). For example, in a case where the number of surveillance cameras 9, by which damage is determined to be present, is one or more or exceeds a predetermined number, the surveillance apparatus 10 determines damage to be present with respect to the situation of damage of the store. In addition, in a case where the number of surveillance cameras 9 by which damage is determined to be present is equal to or less than a predetermined number, and the number of surveillance cameras 9 by which unknown damage is determined is one or more, the surveillance apparatus 10 determines the situation of damage of the store to be unknown. In addition, in a case where the surveillance cameras 9 by which damage is determined to be present is equal to or less than the predetermined number, and there are no surveillance cameras 9 by which unknown damage is determined, the surveillance apparatus 10 determines damage not to be present with respect to the situation of damage of the store.

The surveillance apparatus 10 selects one representative image from a plurality of latest images captured by a plurality of surveillance cameras 9 in the same store and stored in the image DB 17 (S79). The surveillance apparatus 10 may make a random selection, and may select an image captured by a predetermined surveillance camera 9 as the representative image. In addition, the surveillance apparatus 10 may select an image indicating the situation of damage determined in step (S78) as the representative image. In a case where the situation of damage of a store is determined to be unknown, the surveillance apparatus 10 determines information indicating that an image is not acquired.

The surveillance apparatus 10 outputs a display associating, for each store, information indicating non-acquisition of the representative image or an image of a store with information indicating the situation of damage determined with respect to the store (S80). Insofar as the damage situation information is displayed in a state to allow the situations of damage to be distinguished from each other, there is no limitation on its specific display form. In addition, there is also no limitation on a display form of information indicating non-acquisition of an image. In the example of FIG. 6, the pieces of damage situation information are distinguished from each other in the display form of a frame, and the information indicating non-acquisition of an image is displayed by a white image.

The surveillance apparatus 10 determines whether time information indicating a time after the time of the image selected in step (S73) is stored in the image DB 17 (S81). This is a determination of whether a cycle for acquiring a new image has arrived. In a case where the time information after the time of the image selected in step (S73) is stored (S81; YES), the surveillance apparatus 10 selects a new image associated with the time information (S73). The surveillance apparatus 10 executes step (S74) and subsequent steps on this newly selected image. Thereby, in a case where the situation of damage of a store determined in step (S78) has changed from the previous determination, the surveillance apparatus 10 updates the representative image of the store with a new image, and updates the damage situation information with information indicating the situation of newly determined damage in step (S80).

The image surveillance method in the first example embodiment is not limited to the example of FIG. 7. In the example of FIG. 7, a display for each store is output, but a display for each of the surveillance cameras 9 may be output in addition to the display for each store or instead of the display for each store. In this case, steps (S78) and (S79) are not required. The order of the steps executed in the surveillance apparatus 10 in the first example embodiment is not limited to the example shown in FIG. 7. The order of the steps executed can be changed within a range without causing any problem in terms of contents. For example, step (S76) may be executed during the selection (S79) of the representative image of a store.

[Advantageous Effect of First Example Embodiment]

As described above, in the first example embodiment, the event information is acquired, images captured before and after the reference time corresponding to the event information among images captured by a certain surveillance camera 9 are compared with each other, and the situation of damage is determined on the basis of the comparison result. A display is output associating information indicating the determined situation of damage with the images captured by the surveillance camera 9. As a result, a person viewing this output can easily recognize the situation of damage due to the occurrence of an event (for example, earthquake) indicated by the event information, together with the images captured by the surveillance camera 9. That is, according to the first example embodiment, it is possible to provide information indicating the influence of an event indicated by the event information. In this manner, in the first example embodiment, on the assumption that an image captured before the reference time corresponding to the acquired event information indicates the state of no damage during the normal time, the situation of damage is determined by the comparison of the reference image with each image captured after the reference time. This is different from a method of detecting an event by sequentially executing a comparison between the immediately preceding and immediately following images with respect to respective images aligned in a time-series manner.

On the other hand, a power failure, a communication failure or the like may occur due to the influence of the occurrence of an event, and a situation of non-acquisition of the image captured by the surveillance camera 9 in the image server 5 may occur. Consequently, in the first example embodiment, in a case where the image captured after the reference time is not acquired in the image server 5, the situation of damage is determined to be unknown, and a display is output associating information indicating non-acquisition of an image with information indicating the situation of damage is unknown. As a result, a person viewing this output can immediately recognize that a situation has occurred in which the image from the surveillance camera 9 has not arrived at the image server 5 due to the occurrence of the event, and that the situation of damage is thus in an unperceivable state. Such a state may also be considered as one situation of damage. Recognizing such a state is extremely important, since recognizing an unperceivable state allows to grasp the necessity to recognize the situation of a store in such a state by other means

In a case where the situation has been restored from the aforementioned situation to a situation allowing acquisition of an image in the image server 5, the image captured before the reference time and a newly acquired image are compared with each other, and thus the situation of damage determined as unknown is updated to a situation of damage corresponding to anew comparison result. The information indicating non-acquisition of an image is replaced by the new image, and the information indicating the unknown situation of damage is changed to information indicating the updated situation of damage. That is, according to the present example embodiment, it is possible to easily recognize a change in the situation of damage by surveilling a display output.

In addition, in the first example embodiment, the situation of damage is determined with respect to a store of the in-store system 7 on the basis of the result of comparison between the images for each of the surveillance cameras 9 within the in-store system 7. A display is output associating the information indicating non-acquisition of the representative image or an image of a store with the information indicating the situation of damage determined with respect to the store. Therefore, according to the present example embodiment, it is possible to allow a person viewing at the display output to recognize the situation of damage for each store, at a glance, together with a latest image captured by the surveillance camera 9 installed in the store. It is thus possible to quickly cope with damage occurring in the store.

For example, in a case where an event (such as an earthquake) occurs which may inflict damage on stores, the head office which is a franchiser of convenience stores is required to immediately recognize the situations of damage of a large number of convenience stores which are franchisees. In a case where the surveillance system 1 in the first example embodiment is not introduced, the head office is required to make contact with a plurality of persons in charge such as area managers in order to recognize the situations. However, in a case where an event such as a disaster occurs, there is the possibility of communication infrastructure being disrupted or not functioning due to congestion, and there is the possibility that recognizing the situation of each store may take a very long time. In contrast, by introducing the surveillance system 1 according to the first example embodiment, the head office can immediately know the situation of damage of each convenience store by viewing the output of the surveillance system 1, and can immediately cope with, if any, a store in which damage has occurred. In addition, regarding a store of which the situation of damage is determined to be unknown, it is possible to make an attempt to recognize the situation of the store through a different means.

In addition, it has been found by the verification of the inventor that a power failure or a communication trouble breaks out not immediately after the occurrence of a disaster such as an earthquake, but after a few minutes has elapsed from the occurrence. Therefore, there is high possibility that an image captured immediately after an occurrence of an event to before the outbreak of a power failure or a communication trouble can be acquired in the image server 5. According to the first example embodiment, an image captured before the event occurrence time and an image captured thereafter are compared with each other, and thus it is possible to recognize the situation of damage immediately after the occurrence of an event. Further, even in a case where an image from the surveillance camera 9 is temporarily disrupted, it is possible to recognize the latest situation of damage, using the latest image obtained after the restoration of a power failure or the like.

### Second Example Embodiment

Among events which may be indicated by the above-described event information, there is an event that continuously occurs after a certain event has occurred, like an aftershock. Hereinafter, such an event may be denoted as an interlock event, and an event preceding the interlock event may be denoted as a preceding event. Generally, the interlock event is smaller in scale than the preceding event. However, even when there seems to be no damage by the preceding event, damage may become conspicuous by the following interlock event. For example, a principal earthquake is a preceding event, and an aftershock is an interlock event. The above-described first exemplary embodiment does not refer to the handling of such an interlock event. Therefore, in a second exemplary embodiment, a description will be given with a focus on the handling of the interlock event in the second example embodiment. Hereinafter, a surveillance system 1 in the second example embodiment will be described with a focus on contents different from those in the first example embodiment. In the following description, the same contents as those in the first example embodiment will not be repeated.

[Process Configuration]

A surveillance apparatus 10 in the second example embodiment has the same process configuration as that in the first example embodiment.

An event acquisition unit 22 acquires first event information indicating a preceding event and thereafter acquires second event information indicating an interlock event.

The following two methods exist for handling an interlock event. A comparison unit 23 executes any one of the following two methods. However, the comparison unit 23 may handle an interlock event using another method.

<First Method>

A first method considers whether a second reference time corresponding to the second event information indicates a time before elapse of a predetermined time period from a first reference time corresponding to the first event information. When the first event information is acquired the comparison unit 23 selects an image captured before the first reference time, as a reference image, from images captured by the surveillance camera 9, as is the case with the first example embodiment. When the second event information is acquired, the comparison unit 23 determines whether the second reference time corresponding to the second event information indicates a time before elapse of a predetermined time period from the first reference time, and determines whether to select a new reference image in accordance with the determination result. Specifically, in a case where the second reference time indicates a time before elapse of a predetermined time period from the first reference time, the comparison unit 23 maintains the reference image selected during the first event acquisition, and does not select a new reference image in accordance with the second event acquisition. On the other hand, in a case where the second reference time indicates a time after elapse of a predetermined time period from the first reference time, the comparison unit 23 selects a new reference image on the basis of the acquired second event information.

In a case where the interval between events is short, damage caused due to a preceding event is more likely to remain, as it is, during an interlock event. Thus, the reference image selected during the interlock event is likely to indicate a state where damage has occurred. Consequently, according to the first method, in a case where the interval between reference times corresponding to two pieces of event information is shorter than a predetermined time period, it is determined that the second event information indicates an interlock event of a preceding event indicated by the first event information. This predetermined time period is set to, for example, 12 hours, 24 hours or the like, and is held in advance by the comparison unit 23. In a case where the second event information indicates an interlock event, the reference image selected during the acquisition of the first event is maintained, as it is, during the acquisition of the second event information. Thereby, it is possible to prevent erroneous determination of the situation of damage due to setting of an image indicating an occurrence of damage as the reference image.

<Second Method>

A second method considers the situation of damage determined during the acquisition of the first event information without considering the elapse of a predetermined time period as described above. When the first event information is acquired, the comparison unit 23 selects an image captured before the first reference time, as the reference image, from images captured by the surveillance camera 9, as is the case with the first example embodiment. The comparison unit 23 determines the situation of damage by comparing the selected reference image with an image captured after the first reference time. The comparison unit 23 holds the determined situation of damage. When the second event information is acquired, the comparison unit 23 determines whether to select a new reference image in accordance with the previous situation of damage determined with respect to the surveillance camera 9 using the reference image selected on the basis of the first reference time. Specifically, in a case where the held situation of damage is determined as damage or unknown, the comparison unit 23 maintains the held reference image as it is, and does not select a new reference image in accordance with the acquisition of the second event. On the other hand, in a case where the situation of damage already determined during the acquisition of the first event information is determined as no damage, the comparison unit 23 selects a new reference image in accordance with the acquisition of the second event.

According to the second method, since it can be directly determined whether an image intended to beset as the reference image indicates a state where damage has occurred, it is possible to prevent erroneous determination of the situation of damage due to setting of an image indicating an occurrence of damage as the reference image.

[Operation Example/Image Surveillance Method]

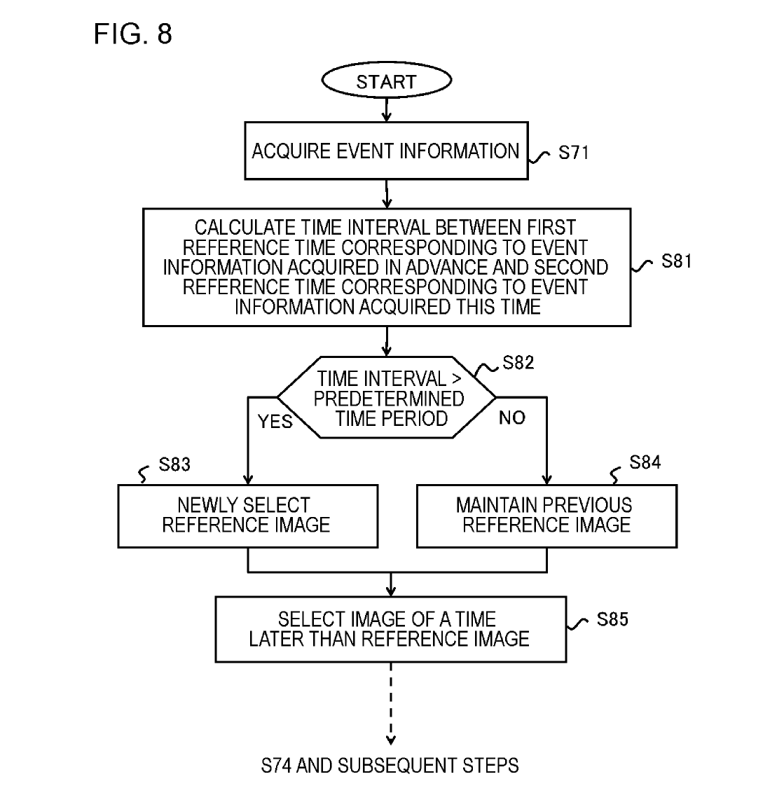

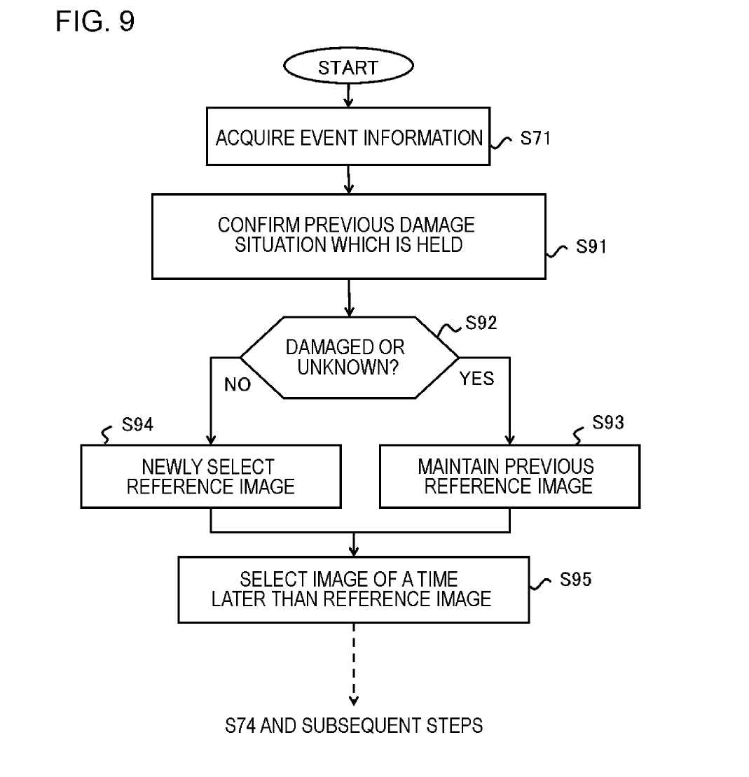

Hereinafter, an image surveillance method in the second example embodiment will be described with reference to FIGS. 8 and 9. FIG. 8 is a flow diagram illustrating a portion of the operation example (first method) of the surveillance apparatus 10 in the second example embodiment. FIG. 9 is a flow diagram illustrating a portion of the operation example (second method) of the surveillance apparatus 10 in the second example embodiment. As shown in FIGS. 8 and 9, the image surveillance method is executed by at least one computer such as the surveillance apparatus 10. Each of steps shown is executed by, for example, each processing module of the surveillance apparatus 10. Each step is the same as the aforementioned processing details of each processing module of the surveillance apparatus 10, and thus the details of each step will not be repeated.

First, the image surveillance method using the aforementioned first method will be described with reference to FIG. 8.

As is the case with the first example embodiment, the surveillance apparatus 10 acquires event information (S71). Here, it is assumed that another event information is acquired prior to the acquired event information, and that the surveillance apparatus operates on the basis of the another event information acquired, as is the case with the first example embodiment.

The surveillance apparatus 10 calculates a time interval between the first reference time corresponding to the event information acquired in advance and the second reference time corresponding to the event information acquired this time (S81). In a case where the time interval is longer than a predetermined time period (S82; YES), the surveillance apparatus 10 newly selects an image captured after the first reference time and before the second reference time as the reference image (S83). On the other hand, in a case where the time interval is shorter than the predetermined time period (S82; NO), the surveillance apparatus 10 maintains the reference image previously selected on the basis of the first reference time as it is (S84).

The surveillance apparatus 10 selects an image stored in association with a time after the selected reference image (S85). Hereinafter, step (S74) and subsequent steps shown in FIG. 7 are executed as is the case with the first example embodiment.

Next, the image surveillance method using the above-described second method will be described with reference to FIG. 9.

After the event information is acquired (S71), the surveillance apparatus 10 checks the previous situation of damage which is held therein (S91). In other words, the surveillance apparatus 10 checks the previous situation of damage determined with respect to the same surveillance camera 9 using the reference image selected on the basis of the first reference time corresponding to the event information acquired in advance (S91).

In a case where the previous situation of damage is determined as damage or unknown (S92; YES), the surveillance apparatus 10 maintains the previous reference image, that is, the reference image selected on the basis of the first reference time corresponding to the event information acquired in advance, as it is (S93). On the other hand, in a case where the previous situation of damage is determined as no damage (S92; NO), the surveillance apparatus 10 newly selects an image captured after the first reference time and before the second reference time corresponding to the event information acquired this time, as the reference image (S94).

The surveillance apparatus 10 selects an image stored in association with a time after the selected reference image (S95). Hereinafter, step (S74) and subsequent steps shown in FIG. 7 are executed as is the case with the first example embodiment.

[Advantageous Effect of Second Example Embodiment]

In the second example embodiment, in a case where a certain event information is acquired, it is determined whether to newly select a reference image on the basis of a reference time corresponding to the event information, or to maintain the reference image already selected on the basis of a reference time corresponding to event information acquired before the event information. Therefore, according to the second example embodiment, it is possible to prevent erroneous determination of the situation of damage due to setting of an image indicating an occurrence of damage as the reference image.

### Third Example Embodiment

In each of the example embodiments described above, an event type which may be indicated by the acquired event information is not particularly mentioned. In each of the example embodiments described above, event information indicating a kind of event such as an earthquake may be an acquisition target. Incidentally, the surveillance system 1 can also acquire multiple types of event information indicating multiple types of predetermined events. For example, it is possible to acquire multiple types of event information such as event information indicating the occurrence of an earthquake and event information indicating an emergency warning of a heavy rain, a windstorm, a snowstorm, or a heavy snow.

Incidentally, it is necessary to change the method of selecting a reference image depending on the event type. For example, the time of occurrence of an earthquake is specified in event information indicating the occurrence of an earthquake, and damage from an earthquake occurs immediately after the occurrence time. Thus, in a case where the event information indicating the occurrence of an earthquake is acquired, an image captured immediately before the time of occurrence of the earthquake may be selected as a reference image. On the other hand, in the event information indicating an emergency warning of a heavy rain, a windstorm, a snowstorm, or a heavy snow, rough occurrence time zones such as nighttime, early morning, daytime, or the like are often shown. In this case, when ensuring setting of an image indicating a situation during the normal time when damage does not occur as a reference image, it is preferable that an image captured before a predetermined time period (for example, 6 hours) from a reference time (for example, o'clock at midnight) corresponding to the event information is selected as the reference image. Hereinafter, a surveillance system 1 in a third example embodiment will be described with a focus on contents different from those in the first example embodiment and the second example embodiment. In the following description, the same contents as those in the first example embodiment and the second example embodiment will not be repeated.

[Process Configuration]

A surveillance apparatus 10 in the third example embodiment has the same process configuration as that in the first example embodiment and the second example embodiment.

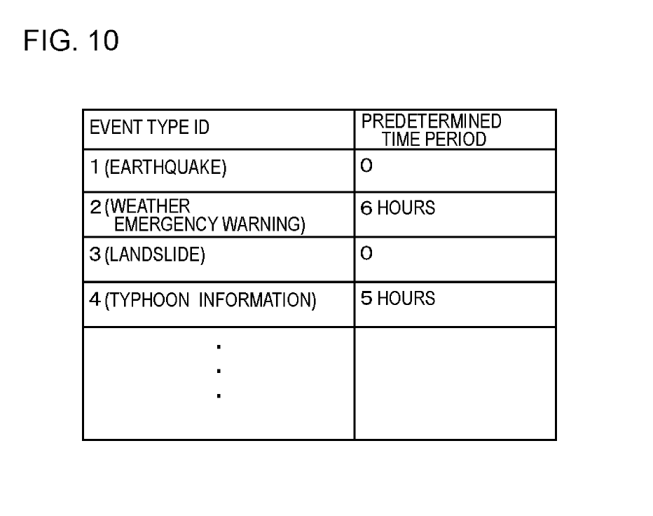

A comparison unit 23 selects an image captured before a predetermined time period corresponding to an event type of the acquired event information from a reference time corresponding to the event information, as a reference image. For example, the comparison unit 23 previously holds a table in which event types and predetermined time periods as illustrated in FIG. 10 are stored in association with each other.

FIG. 10 is a diagram illustrating an example of a table in which event types and predetermined time periods are stored in association with each other. In the example of FIG. 10, an event type ID for identifying an event type and a predetermined time period are associated with each other. In a case where event information indicating an earthquake is acquired, the comparison unit 23 selects an image captured immediately before (predetermined time period “0”) a reference time (for example, earthquake occurrence time) corresponding to the event information, as a reference image. In a case where event information indicating a weather emergency warning is acquired, the comparison unit 23 selects image captured before a predetermined time period (6 hours) from a reference time corresponding to the event information, as a reference image. However, a predetermined time period or an event type to be processed by the surveillance system 1 is not limited to the example of FIG. 10. The predetermined time period is determined for each event type on the basis of the credibility of a reference time corresponding to event information, or the like.

[Operation Example/Image Surveillance Method]

Hereinafter, an image surveillance method in the third example embodiment will be described with reference to FIG. 7.

In step (S72), the surveillance apparatus 10 acquires an event type indicated by the event information acquired in step (S71), and determines a predetermined time period corresponding to the event type. The surveillance apparatus 10 selects an image captured before the determined predetermined time period from a reference time corresponding to the acquired event information, as a reference image (S72). Other steps are the same as those in the first example embodiment and the second example embodiment.

[Advantageous Effect of Third Example Embodiment]

As described above, the third example embodiment determines how long ago before the reference time corresponding to the event information the image to be set as the reference image should be acquired from, on the basis of an event type indicated by the acquired event information. Thereby, according to the third example embodiment, even in a case where multiple types of pieces of event information are handled, it is possible to select an image indicating a state during a normal time without the occurrence of damage as a reference image, and to prevent the situation of damage from being erroneously determined.

### Fourth Example Embodiment

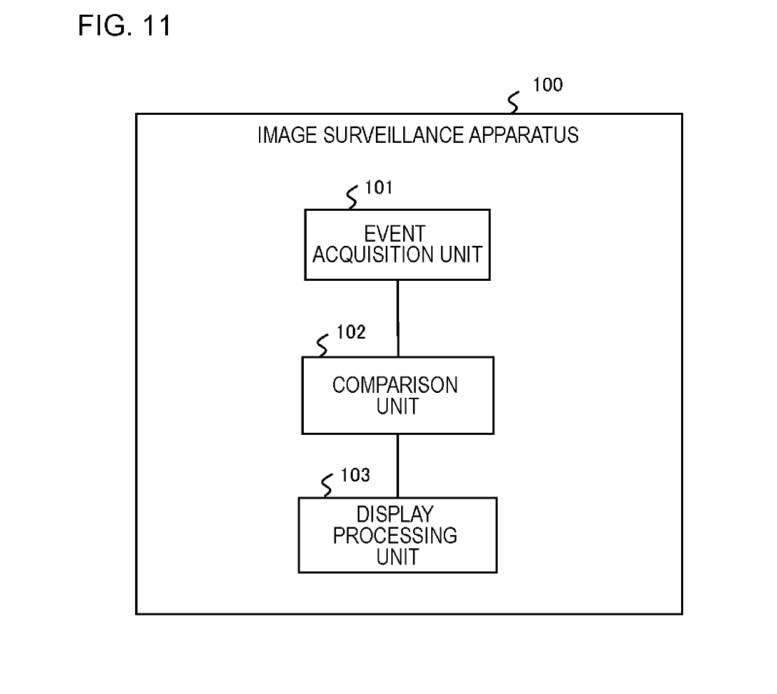

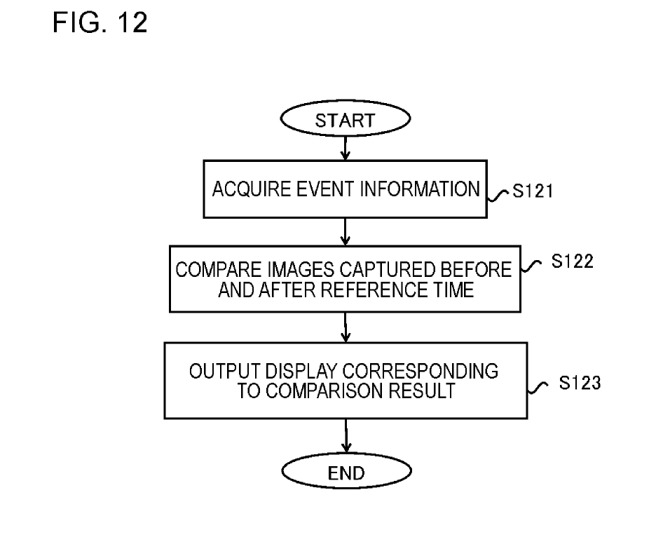

Hereinafter, an image surveillance apparatus and an image surveillance method in a fourth example embodiment will be described with reference to FIGS. 11 and 12. In addition, the fourth example embodiment may be a program causing at least one computer to execute this image surveillance method, and may be a storage medium having such a program stored thereon which is readable by the at least one computer.

FIG. 11 is a diagram conceptually illustrating a process configuration example of an image surveillance apparatus 100 in the fourth example embodiment. As shown in FIG. 11, the image surveillance apparatus 100 includes an event acquisition unit 101, a comparison unit 102, and a display processing unit 103. The image surveillance apparatus 100 shown in FIG. 11 has, for example, the same hardware configuration as that of the above-described surveillance apparatus 10 shown in FIG. 1. The event acquisition unit 101, the comparison unit 102 and the display processing unit 103 are implemented by executing a program stored in the memory 12 by the CPU 11. In addition, the program may be installed from, for example, a portable storage medium such as a CD or a memory card, or another computer on a network through the communication unit 13, and be stored in the memory 12. The input apparatus 16 and the display apparatus 15 may not be connected to the image surveillance apparatus 100.

The event acquisition unit 101 acquires event information. The acquired event information is information, indicating a predetermined event, which is generated accompanying the occurrence of the event. The event information indicates a predetermined event other than an event detected from an image captured by an imaging apparatus. Insofar as the predetermined event is an event having the possibility of damaging a store, there is no limitation on its contents. The specific processing details of the event acquisition unit 101 are the same as those of the above-described event acquisition unit 22.

The comparison unit 102 compares images captured before and after a reference time corresponding to the event information acquired by the event acquisition unit 101, among images captured by an imaging apparatus. The imaging apparatus is an apparatus that captures an image, and is, for example, the above-described surveillance camera 9. The imaging apparatus may be a camera built into the image surveillance apparatus 100. In addition, the “reference time corresponding to the event information” may be a time of occurrence of an event indicated by the event information, and may be a time at which the event information is acquired by the event acquisition unit 101. In addition, there is no limitation on the unit of the reference time. The reference time may be indicated by seconds, or may be indicated by minutes or hours. The “images captured before and after the reference time” may be an image captured immediately after the reference time and an image captured immediately before the reference time, or may be an image captured before a predetermined time period from the reference time and a latest image the at or after the reference time. In addition, there is no limitation on a method of comparison between images. The specific processing details of the comparison unit 102 are the same as those of the above-described comparison unit 23.

The display processing unit 103 outputs a display, corresponding to the result of the comparison performed by the comparison unit 102, to a display unit. The display unit may be the display apparatus 15 connected to the image surveillance apparatus 100, or may be a monitor included in another apparatus. Insofar as the display corresponding to the result of the comparison is a display of contents based on the comparison result, there is no limitation on its specific display contents. For example, the display may include information indicating a difference between images which is calculated by the comparison between images. In addition, the display may include some kind of information derived from a difference between images, such as the situation of damage described above.

FIG. 12 is a flow diagram illustrating an operation example of the image surveillance apparatus 100 in the fourth example embodiment. As shown in FIG. 12, an image surveillance method in the fourth example embodiment is executed by at least one computer such as the image surveillance apparatus 100. For example, each of steps shown is executed by each processing module included in the image surveillance apparatus 100. Each step is the same as the aforementioned processing details of each processing module of the image surveillance apparatus 100, and thus the details of each step will not be repeated.

The image surveillance method in the present example embodiment includes steps (S121), (S122) and (S123). In step (S121), the image surveillance apparatus 100 acquires event information. In step (S122), the image surveillance apparatus 100 compares images captured before and after a reference time corresponding to the event information acquired in step (S121), among images captured by an imaging apparatus. In step (S123), the image surveillance apparatus 100 outputs display corresponding to the result of the comparison in step (S122) to a display unit. The display unit may be included in the computer which is the execution subject of the image surveillance method, and may be included another apparatus capable of communicating with the computer.

According to the fourth example embodiment, it is possible to obtain the same advantageous effect as those in the first, second and third example embodiments described above.

Note that, in a plurality of flow diagrams using the aforementioned description, a plurality of steps (processes) are described in order, but the order of steps executed in each of the example embodiments is not restricted to the described order. In each of the example embodiments, the order of the steps shown can be changed within the range without any problem in terms of contents. In addition, each of the example embodiments described above can be combined in the range consistent with the contents thereof.

The above-described contents may be determined as follows. However, the above-described contents are not limited to the following descriptions.

1. An image surveillance apparatus including:

an event acquisition unit that acquires event information;

a comparison unit that compares images captured before and after a reference time corresponding to the acquired event information, among images captured by an imaging apparatus; and

a display processing unit that outputs a display corresponding to a result of the comparison to a display unit.

2. The image surveillance apparatus according to 1,

in which the comparison unit determines a situation of damage on the basis of the result of the comparison, and

the display processing unit outputs a display associating information indicating the determined situation of damage with the images captured by the imaging apparatus to the display unit.

3. The image surveillance apparatus according to 1 or 2,

in which the comparison unit determines the situation of damage as unknown in a case where an image captured after the reference time captured by the imaging apparatus is not acquired, and

the display processing unit outputs a display associating information indicating non-acquisition of an image captured by the imaging apparatus with information indicating an unknown situation of damage to the display unit.

4. The image surveillance apparatus according to 3,

in which in a case where a new image is acquired after the situation of damage is determined as unknown, the comparison unit compares an image captured before the reference time with the new image, to thereby update the situation of damage determined as unknown to a situation of damage corresponding to a new result of the comparison, and

the display processing unit replaces the information indicating non-acquisition of an image with the new image, and changes the information indicating the unknown situation of damage to information indicating the updated situation of damage.

5. The image surveillance apparatus according to 3 or 4, further including a reference unit that refers to an image storage unit that stores an image captured by an imaging apparatus, for each store and for each imaging apparatus installed in the store,

in which the comparison unit determines a situation of damage with respect to each store, on the basis of a result of comparison between images for each imaging apparatus stored in the image storage unit, and

the display processing unit outputs a display associating, for each store, information indicating non-acquisition of a representative image or an image of a store stored in the image storage unit with information indicating a situation of damage determined with respect to the store to the display unit.

6. The image surveillance apparatus according to 5, in which the display processing unit selects, from a plurality of latest images for each store stored in the image storage unit, an image indicating the determined situation of damage as a representative image of each store.

7. The image surveillance apparatus according to 5 or 6,

in which the display processing unit outputs, to the display unit, a map display in which a display element is disposed at a position of each store, the display element associating the information indicating non-acquisition of a representative image or an image of a store with the information indicating a situation of damage of each store.

8. The image surveillance apparatus according to any one of 5 to 7, in which the comparison unit determines a situation of damage for each imaging apparatus on the basis of the result of comparison between images for each imaging apparatus stored in the image storage unit, and determines a situation of damage with respect to each store on the basis of a plurality of situations of damage determined with respect to a plurality of imaging apparatuses disposed in the same store.

9. The image surveillance apparatus according to any one of 5 to 8, in which the comparison unit determines a situation of damage with respect to a store, on the basis of a situation of damage determined with respect to an imaging apparatus disposed in the store and a situation of damage determined with respect to another store.

10. The image surveillance apparatus according to any one of 1 to 9,

in which the event acquisition unit acquires first event information and thereafter acquires second event information, and

the comparison unit

selects, when the first event information is acquired, an image captured before a first reference time corresponding to the acquired first event information, as a reference image to be compared, from images captured by the imaging apparatus, and

determines, when the second event information is acquired, whether a second reference time corresponding to the second event information indicates a time before elapse of a predetermined time period from the first reference time, and determines whether to select a new reference image in accordance with a result of the determination.

11. The image surveillance apparatus according to any one of 2 to 9,

in which the event acquisition unit acquires first event information and thereafter acquires second event information, and

the comparison unit

selects, when the first event information is acquired, an image captured before a first reference time corresponding to the acquired first event information, as a reference image, from images captured by the imaging apparatus, and determines a situation of damage by comparing the selected reference image with an image captured after the first reference time, and

determines, when the second event information is acquired, whether to select a new reference image in accordance with the previous situation of damage determined with respect to the imaging apparatus using the reference image selected on the basis of the first reference time.

12. The image surveillance apparatus according to any one of 1 to 11, in which the comparison unit selects an image, captured before a predetermined time period corresponding to an event type of the acquired event information, from the reference time as a reference image to be compared.

13. An image surveillance method executed by at least one computer, the method including:

acquiring event information;

comparing images captured before and after a reference time corresponding to the acquired event information, among images captured by an imaging apparatus; and

outputting a display corresponding to a result of the comparison to a display unit.

14. The image surveillance method according to 13, further including determining a situation of damage on the basis of the result of the comparison,

in which the step of outputting a display is outputting of the display in which information indicating the determined situation of damage is associated with the images captured by the imaging apparatus.

15. The image surveillance method according to 13 or 14, further including determining the situation of damage as unknown in a case where an image captured after the reference time by the imaging apparatus is not acquired,

in which the step of outputting a display is outputting of the display in which information indicating non-acquisition of an image captured by the imaging apparatus is associated with information indicating an unknown situation of damage.

16. The image surveillance method according to 15, further including:

comparing an image captured before the reference time with a new image in a case where the new image is acquired after the situation of damage is determined as unknown;

updating the situation of damage determined as unknown to a situation of damage corresponding to the result of the comparison; and

replacing the information indicating non-acquisition of an image with the new image, and changing the information indicating the unknown situation of damage to information indicating the updated situation of damage.

17. The image surveillance method according to 15 or 16, further including:

referring to an image storage unit that stores an image captured by an imaging apparatus, for each store and for each imaging apparatus installed in the store;

determining a situation of damage with respect to each store, on the basis of a result of comparison between images for each imaging apparatus stored in the image storage unit; and

outputting, to the display unit, a display in which information indicating non-acquisition of a representative image or an image of a store stored in the image storage unit is associated with information indicating a situation of damage determined with respect to the store for each store.

18. The image surveillance method according to 17, further including selecting an image indicating the determined situation of damage, as a representative image of each store, from a plurality of latest images for each store stored in the image storage unit.

19. The image surveillance method according to 17 or 18, further including outputting, to the display unit, a map display in which a display element is disposed at a position of each store, the display element associating the information indicating non-acquisition of a representative image or an image of a store with the information indicating a situation of damage of the store.

20. The image surveillance method according to any one of 17 to 19, in which the step of determining a situation of damage with respect to each store includes

determining a situation of damage for each imaging apparatus on the basis of the result of comparison between images for each imaging apparatus stored in the image storage unit, and

determining a situation of damage with respect to each store on the basis of a plurality of situations of damage determined with respect to a plurality of imaging apparatuses disposed in the same store.

21. The image surveillance method according to any one of 17 to 20, in which the step of determining a situation of damage with respect to each store includes determining a situation of damage with respect to a store, on the basis of a situation of damage determined with respect to an imaging apparatus disposed in the store and a situation of damage determined with respect to another store.

22. The image surveillance method according to any one of 13 to 21, further including:

acquiring first event information and thereafter acquiring second event information;

selecting, when the first event information is acquired, an image captured before a first reference time corresponding to the acquired first event information, as a reference image to be compared, from images captured by the imaging apparatus; and

determining, when the second event information is acquired, whether a second reference time corresponding to the second event information indicates a time before elapse of a predetermined time period from the first reference time, and determining whether to select a new reference image in accordance with a result of the determination.

23. The image surveillance method according to any one of 14 to 21, further including:

acquiring first event information and thereafter acquiring second event information;

selecting, when the first event information is acquired, an image captured before a first reference time corresponding to the acquired first event information, as a reference image, from images captured by the imaging apparatus;

determining a situation of damage by comparing the selected reference image with an image captured after the first reference time; and

determining, when the second event information is acquired, whether to select a new reference image in accordance with the previous situation of damage determined with respect to the imaging apparatus using the reference image selected on the basis of the first reference time.

24. The image surveillance method according to any one of 13 to 23, further including selecting an image captured before a predetermined time period corresponding to an event type of the acquired event information from the reference time, as a reference image to be compared.

25. A program causing at least one computer to execute the image surveillance method according to any one of 13 to 24.

This application claims priority from Japanese Patent Application No. 2015-055242 filed on Mar. 18, 2015, the content of which is incorporated herein by reference in its entirety.

1. An image surveillance apparatus comprising:
a memory configured to store instructions; and
a processor configured to execute the instructions to:
acquire information;
compare, for each sore, images captured before and after a reference time corresponding to the acquired event information, among images captured by an imaging apparatus installed for each store; and
output a display corresponding to a result of the comparison of each store to a display unit.

2. The image surveillance apparatus according to claim 1,
wherein the processor is further configured to execute the instructions to:
determine a situation of damage on the basis of the result of the comparison; and
output a display associating information indicating the determined situation of damage with the images captured by the imaging apparatus to the display unit.

3. The image surveillance apparatus according to claim 1,
wherein the processor is further configured to execute the instructions to determine the situation of damage as unknown in a case where an image captured after the reference time captured by the imaging apparatus is not acquired, and
output a display associating information indicating non-acquisition of an image captured by the imaging apparatus with information indicating an unknown situation of damage to the display unit.

4. The image surveillance apparatus according to claim 3,
wherein the processor is further configured to execute the instructions to:
compare, in a case where a new image is acquired after the situation of damage is determined as unknown, an image captured before the reference time with the new image, to thereby update the situation of damage determined as unknown to a situation of damage corresponding to a new result of the comparison; and
replace the information indicating non-acquisition of an image with the new image, and changes the information indicating the unknown situation of damage to information indicating the updated situation of damage.

5. The image surveillance apparatus according to claim 3,
wherein the processor is further configured to execute the instructions to:
refer to an image storage unit that stores an image captured by an imaging apparatus, for each store and for each imaging apparatus installed in the store;
determine a situation of damage with respect to
each store, on the basis of a result of comparison between images for each imaging apparatus stored in the image storage unit; and
output a display associating, for each store, information indicating non-acquisition of a representative image or an image of a store stored in the image storage unit with information indicating a situation of damage determined with respect to the store to the display unit.

6. The image surveillance apparatus according to claim 5, wherein processor is further configured to execute the instructions to select, from a plurality of latest images for each store stored in the image storage unit, an image indicating the determined situation of damage as a representative image of each store.

7. The image surveillance apparatus according to claim 5,
wherein the processor is further configured to execute the instructions to output, to the display unit, a map display in which a display element is disposed at a position of each store, the display element associating the information indicating non-acquisition of a representative image or an image of a store with the information indicating a situation of damage of the store.

8. The image surveillance apparatus according to claim 5, wherein the processor is further configured to execute the instructions to determine a situation of damage for each imaging apparatus on the basis of the result of comparison between images for each imaging apparatus stored in the image storage unit, and determines a situation of damage with respect to each store on the basis of a plurality of situations of damage determined with respect to a plurality of imaging apparatuses disposed in the same store.

9. The image surveillance apparatus according to claim 5, wherein the processor is further configured to execute the instructions to determine a situation of damage with respect to a store, on the basis of a situation of damage determined with respect to an imaging apparatus disposed in the store and a situation of damage determined with respect to another store.

10. The image surveillance apparatus according claim 1
wherein the processor is further configured to execute the instructions to:
first event information and thereafter acquires second event information;
select, when the first event information is acquired, an image captured before a first reference time corresponding to the acquired first event information, as a reference image to be compared, from images captured by the imaging apparatus; and
determine, when the second event information is acquired, whether a second reference time corresponding to the second event information indicates a time before elapse of a predetermined time period from the first reference time, and determines whether to select a new reference image in accordance with a result of the determination.

11. The image surveillance apparatus according to claim 2,
wherein the processor is further configured to execute the instructions to:
acquire first event information and thereafter acquires second event information;
select, when the first event information is acquired, an image captured before a first reference time corresponding to the acquired first event information, as a reference image, from images captured by the imaging apparatus, and determines a situation of damage by comparing the selected reference image with an image captured after the first reference time; and
determine, when the second event information is acquired, whether to select a new reference image in accordance with the previous situation of damage determined with respect to the imaging apparatus using the reference image selected on the basis of the first reference time.

12. The image surveillance apparatus according to claim 1, wherein the processor is further configured to execute the instructions to select an image captured before a predetermined time period corresponding to an event type of the acquired event information from the reference time as a reference image to be compared.

13. An image surveillance method executed by at least one computer, the method comprising:
acquiring event information;
comparing, for each store, images captured before and after a reference time corresponding to the acquired event information, among images captured by an imaging apparatus installed for each store; and
arranging and outputting a display corresponding to a result of the comparison of each store to a display unit.

14. A non-transitory computer readable medium storing a program causing at least one computer to execute a image surveillance method, the image surveillance method comprising:
acquiring event information;
comparing, for each store, images captured before and after a reference time corresponding to the acquired event information, among images captured by an imaging apparatus installed for each store; and
arranging and outputting, a display corresponding to a result of the comparison of each store to a display unit.

15. The image surveillance apparatus according to claim 2,
wherein the processor is further configured to execute the instructions to determine the situation of damage as unknown in a case where an image captured after the reference time captured by the imaging apparatus is not acquired, and
output a display associating information indicating non-acquisition of an image captured by the imaging apparatus with information indicating an unknown situation of damage to the display unit.

16. The image surveillance apparatus according to claim 15,
wherein the processor is further configured to execute the instructions to:
compare, in a case where a new image is acquired after the situation of damage is determined as unknown, an image captured before the reference time with the new image, to thereby update the situation of damage determined as unknown to a situation of damage corresponding to a new result of the comparison; and
replace the information indicating non-acquisition of an image with the new image, and
changes the information indicating the unknown situation of damage to information indicating the updated situation of damage.

17. The image surveillance apparatus according to claim 4,
wherein the processor is further configured to execute the instructions to:
refer to an image storage unit that stores an image captured by an imaging apparatus, for each store and for each imaging apparatus installed in the store;
determine a situation of damage with respect to each store, on the basis of a result of comparison between images for each imaging apparatus stored in the image storage unit; and
output a display associating, for each store, information indicating non-acquisition of a representative image or an image of a store stored in the image storage unit with information indicating a situation of damage determined with respect to the store to the display unit.

18. The image surveillance apparatus according to claim 15,
wherein the processor is further configured to execute the instructions to:
refer to an image storage unit that stores an image captured by an imaging apparatus, for each store and for each imaging apparatus installed in the store;
determine a situation of damage with respect to each store, on the basis of a result of comparison between images for each imaging apparatus stored in the image storage unit; and
output a display associating, for each store, information indicating non-acquisition of a representative image or an image of a store stored in the image storage unit with information indicating a situation of damage determined with respect to the store to the display unit.

19. The image surveillance apparatus according to claim 16,
wherein the processor is further configured to execute the instructions to:
refer to an image storage unit that stores an image captured by an imaging apparatus, for each store and for each imaging apparatus installed in the store;
determine a situation of damage with respect to each store, on the basis of a result of comparison between images for each imaging apparatus stored in the image storage unit; and
output a display associating, for each store, information indicating non-acquisition of a representative image or an image of a store stored in the image storage unit with information indicating a situation of damage determined with respect to the store to the display unit.

20. The image surveillance apparatus according to claim 17, wherein the processor is further configured to execute the instructions to select, from a plurality of latest images for each store stored in the image storage unit, an image indicating the determined situation of damage as a representative image of each store.
